(19) United States
(12) Patent Application Publication
(10) Pub. No.: US 2018/0181948 A1
(43) Pub. Date: Jun. 28, 2018

(54) PAYMENT FACILITATION METHOD AND SYSTEM

(71) Applicant: MasterCard International Incorporated, Purchase, NY (US)

(72) Inventors: Piyush Sharma, Pune (IN); Elson Rodriques, Mumbai (IN)

(21) Appl. No.: 15/829,308

(22) Filed: Dec. 1, 2017

(30) Foreign Application Priority Data
Dec. 23, 2016 (SG) 10201610825Q

(51) Int. Cl. G06Q 20/32; G06Q 20/40; G06K 19/06

(52) U.S. Cl. CPC G06Q 20/3274; G06K 19/06037; G06K 19/06028; G06Q 20/401

(57) ABSTRACT

There is provided a system and method for facilitating a payment from a customer to a merchant. The payment is carried out when a client device presents a barcode associated with the payment on a display of the client device for scanning by a merchant device.

### CROSS-REFERENCE TO RELATED APPLICATION

This application is a U.S. National Stage filing under 35 U.S.C. § 119, based on and claiming benefit of and priority to SG Patent Application No. 10201610825Q filed Dec. 23, 2016.

### BACKGROUND OF THE INVENTION

This invention relates to methods and systems for facilitating a payment from a customer using a client device to a merchant using a merchant device.

### DESCRIPTION OF THE PRIOR ART

Mobile payment services may allow customers to make cashless payments using a portable mobile device such as a smart phone. The most widely adopted implementations rely on the merchant having suitable mobile payment infrastructure, which may be provided in a point of sale (POS) terminal including a Near Field Communication (NFC) reader or the like. The customer interacts with the POS terminal using their mobile device in place of a traditional payment card, such as by swiping, touching or waving their mobile device in close proximity of the POS terminal.

Accordingly, in order to facilitate mobile payments using conventional techniques, a merchant will generally need to have suitable mobile payment acquiring infrastructure installed in their place of business. However, if a merchant cannot afford to install this dedicated infrastructure, then the merchant may be unable to accept mobile payments, which could cause the merchant to miss out on potential sales. It would therefore be desirable to provide a solution for facilitating a mobile payment from a customer to a merchant without requiring the merchant to have dedicated mobile payment infrastructure.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a first aspect, there is provided a system for facilitating a payment from a customer to a merchant. The system includes one or more electronic processing devices configured to: a) receive, from a client device of the customer, a payment authorization including: i) an indication of a payment instrument of the customer for the payment; and, ii) a payment amount for the payment; b) provide, to the client device, a payment authorization response, the payment authorization response causing the client device to present a barcode associated with the payment on a display of the client device for scanning by a merchant device of the merchant; c) receive, from the merchant device, a payment request generated in response to the merchant device scanning the barcode; and, d) cause the payment from the payment instrument of the customer to the merchant to be performed in accordance with the payment authorization and the payment request.

There is also provided a method for facilitating a payment from a customer to a merchant, the method being performed using one or more electronic processing devices. The method includes: a) receiving, from a client device of the customer, a payment authorization including: i) an indication of a payment instrument of the customer for the payment; and, ii) a payment amount for the payment; b) providing, to the client device, a payment authorization response, the payment authorization response causing the client device to present a barcode associated with the payment on a display of the client device for scanning by a merchant device of the merchant; c) receiving, from the merchant device, a payment request generated in response to the merchant device scanning the barcode; and, d) causing the payment from the payment instrument of the customer to the merchant to be performed in accordance with the payment authorization and the payment request.

In another aspect, there is provided a method for facilitating a payment from a customer to a merchant, the method being performed using a client device of the customer. The method includes: a) generating a payment authorization including: i) an indication of a payment instrument of the customer for the payment; and, ii) a payment amount for the payment; b) providing, to an application server, the payment authorization; c) receiving, from the application server, a payment authorization response; d) presenting a barcode associated with the payment on a display of the client device in accordance with the payment authorization response, to allow a merchant device of the merchant to scan the barcode and provide, to the application server, a payment request generated in response to the merchant device scanning the barcode, to thereby allow the application server to cause the payment from the payment instrument of the customer to the merchant to be performed in accordance with the payment authorization and the payment request.

Furthermore, there is provided a client device for facilitating a payment from a customer to a merchant, the client device being configured to: a) generate a payment authorization including: i) an indication of a payment instrument of the customer for the payment; and, ii) a payment amount for the payment; b) provide, to an application server, the payment authorization; c) receive, from the application server, a payment authorization response; d) present a barcode associated with the payment on a display of the client device in accordance with the payment authorization response, to allow a merchant device of the merchant to scan the barcode and provide, to the application server, a payment request generated in response to the merchant device scanning the barcode, to thereby allow the application server to cause the payment from the payment instrument of the customer to the merchant to be performed in accordance with the payment authorization and the payment request.

In addition, there is provided a method for facilitating a payment from a customer to a merchant, the method being performed using a merchant device of the merchant. The method includes: a) scanning, from a display of a client device of the customer, a barcode associated with the payment, the barcode encoding a unique identifier associated with the payment and being presented on the display in accordance with a payment authorization response generated by an application server in response to the client device generating payment authorization including: i) an indication of a payment instrument of the customer for the payment; and, ii) a payment amount for the payment; b) decoding the barcode to obtain the unique identifier; c) generating a payment request in response to the merchant device scanning the barcode, the payment request including the unique identifier and a merchant identifier; and, d) providing, to an application server, the payment request to thereby allow the application server to cause the payment from the payment instrument of the customer to the merchant to be performed in accordance with the payment authorization and the payment request.

In a final aspect, there is provided a merchant device for facilitating a payment from a customer to a merchant, the merchant device being configured to: a) scan, from a display of a client device of the customer, a barcode associated with the payment, the barcode encoding a unique identifier associated with the payment and being presented on the display in accordance with a payment authorization response generated by an application server in response to the client device generating payment authorization including: i) an indication of a payment instrument of the customer for the payment; and, ii) a payment amount for the payment; b) decode the barcode to obtain the unique identifier; c) generate a payment request in response to the merchant device scanning the barcode, the payment request including the unique identifier and a merchant identifier; and, d) provide, to an application server, the payment request to thereby allow the application server to cause the payment from the payment instrument of the customer to the merchant to be performed in accordance with the payment authorization and the payment request.

### BRIEF DESCRIPTION OF THE DRAWINGS

An example of the present invention will now be described with reference to the accompanying drawings, in which:—

FIG. 1 is a flow chart of an example of a method for facilitating a payment from a customer to a merchant;

FIG. 2 is a schematic diagram of an example of a distributed computer architecture;

FIG. 3 is a schematic diagram of an example of a server processing system;

FIG. 4 is a schematic diagram of an example of a client processing system;

FIG. 5 is a schematic diagram of an example of a system configuration for facilitating a payment from a customer to a merchant; and,

FIGS. 6A to 6E are a flow chart of an example of a method of a customer making a payment to a merchant.

### DETAILED DESCRIPTION OF THE PREFERRED EMBODIMENTS

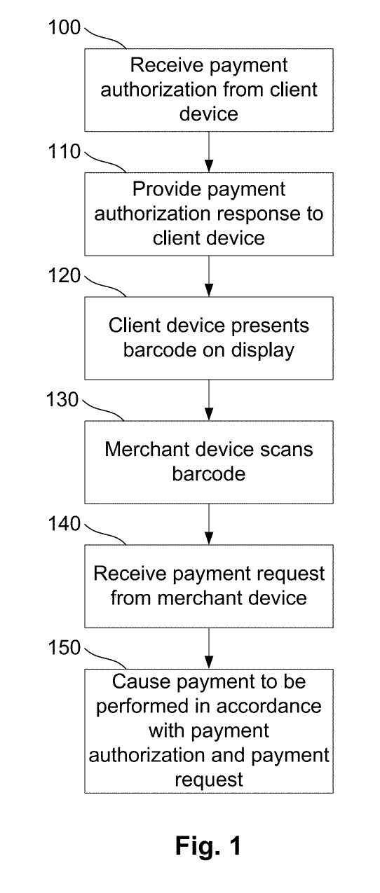

An example of a method for facilitating a payment from a customer to a merchant will now be described with reference to FIG. 1.

The method as exemplified in FIG. 1 is performed using one or more electronic processing devices, which will be referred to as an application server for the purpose of this example. The application server will be configured to communicate with a client device of the customer and a merchant device of the merchant. Each of the client device and the merchant device will be in the form of additional electronic processing devices. The application server may communicate with each of the client device and the merchant device using a communication network.

For the purpose of this example, it will be assumed that the client device may be a suitably configured mobile device such as a smart phone or feature phone, whilst the merchant device may or may not be a mobile device depending on the particular context in which payments are to be made. For instance, a merchant operating a portable business may also use a mobile device such as a smart phone or tablet, but a merchant having a fixed place of business may alternatively use a stationary computing device such as a suitably programmed PC, although a mobile device such as a tablet or smart phone might nevertheless be used in such a fixed place of business. In any event, in this example, it will be assumed that the merchant device is also a mobile device. Suitable examples of electronic processing devices for providing the application server, the client device and the merchant device will be described in more detail below.

Both the client device and the merchant device will typically execute application software for enabling communication with the application server and enabling functionalities of the method. The client device and the merchant device may each operate different application software to provide different functionalities to the customer and the merchant. For the purpose of this example, it is assumed that the customer and the merchant are each registered users of the application software and that the application software is appropriately configured for use with the method. Furthermore, it is assumed that the customer has associated at least one payment instrument (such as a bank account, credit card account, gift card or the like) with the customer's registration to allow payments to be made and the merchant has associated a merchant account with the merchant's registration to allow payments to be received.

Step 100 of the method includes the application server receiving, from a client device of the customer, a payment authorization. The payment authorization includes an indication of a payment instrument of the customer for the payment and a payment amount for the payment. Typically, this step will be performed when the customer wishes to make a payment to the merchant for a purchase of goods or services. For example, this step may be initiated after the customer has selected goods or services for purchase and a total payment amount required to complete the purchase has been confirmed by the merchant. The payment authorization may be generated by the client device in response to the customer selecting a payment instrument from a mobile wallet and entering the payment amount using the application software. Subsequently, the payment authorization is transferred from the client device to the application server.

In step 110, the application server provides, to the client device, a payment authorization response. The payment authorization response subsequently causes the client device to present a barcode associated with the payment on a display of the client device at step 120. The payment authorization response could take a range of different forms depending on the particular implementation of the method. In one example, the payment authorization response may include the barcode to be presented on the client device, with the barcode being generated in the application server to encode payment information such as a unique identifier associated with the payment and potentially other details of the payment such as the payment amount from the payment authorization. Alternatively, the payment authorization response may include a message including payment information as mentioned in the previous example, so that the barcode can be generated locally on the client device based on the payment information. However, in some examples, the payment authorization response may not need to provide any payment information and this may simply provide confirmation that client device can proceed to generate and present the barcode using locally available information.

It should be appreciated that the barcode may be any optical, machine-readable representation of encoded data, and may refer to traditional one-dimensional barcodes, or two-dimensional barcodes (also known as matrix barcodes) such as a QR code, or any other suitable type of black-and-white or colour barcode (such as a High Capacity Color Barcode, HCCB) capable of encoding payment information and being optically scanned. The barcode may be generated using any known barcode encoding techniques.

In any event, the barcode will be presented on the display of the client device, and the barcode is then scanned by the merchant device at step 130. For example, in the case where the merchant device is a smart phone, the barcode may be scanned using an in-built camera of the smart phone. The application software executed on the merchant device may be configured to operate the smart phone camera to capture an image of the barcode and subsequently process the image to decode the payment information encoded in the barcode. However, it will be appreciated that the barcode may be scanned by any suitable scanning hardware associated with the merchant device. For instance, the merchant device may be provided as a point of sale terminal including a dedicated barcode scanner for scanning product barcodes but which may also be used for scanning the barcode on the client device.

At step 140, the application server will receive, from the merchant device, a payment request generated in response to the merchant device scanning the barcode. For example, the payment request may be generated by the merchant device following the merchant's verification of the payment amount that may be obtained using the payment information decoded from the barcode. In the case that the barcode encodes the payment amount, this may be decoded directly from the barcode. Alternatively, in the case that the barcode only encodes a unique identifier for the payment, the merchant device may need to communicate with the application server to obtain the payment amount associated with the unique identifier for verification. The merchant may cause the payment request to be generated by selecting an option in the application software to confirm that the payment should proceed.

In some examples, the payment request generated by the merchant device may include the unique identifier associated with the payment, together with a merchant identifier for allowing the application server to determine the identity of the merchant that is to be the recipient of the payment. Other payment information may also be provided as part of the payment, although it should be noted that sufficient payment information may already be available to the application server from the payment authorization received from the client device.

Following receipt of the payment request, step 150 of the method involves causing the payment from the payment instrument of the customer to the merchant to be performed in accordance with the payment authorization and the payment request. The payment may then be performed using conventional payment techniques, such as by using a payment instrument token associated with the mobile wallet of the customer.

In some examples, the step of causing the payment to be performed may include determining a customer account based on the indication of the payment instrument received in the payment authorization received in step 110, determining a merchant account based on the payment request in step 140 (such as by using a merchant identifier included in the payment request), and causing the customer account to be debited and the merchant account to be credited in accordance with the payment authorization and the payment request. It should be appreciated that the amount credited to the merchant account may be less than the payment amount debited from the customer account, to account for transaction fees that may be payable, such as credit card or debit card interchange fees.

In some implementations, the application server may cause the payment to be performed by generating a payment request message (including, for instance, the payment amount, the customer account and the merchant account as discussed above) and providing the payment request message to a payment server of a payment service provider or the like. The payment server can then perform the payment based on the payment request message in a generally conventional manner.

However, in some examples, the actual payment transaction may involve debiting the customer account at an earlier stage in the method, such as in response to receipt of the payment authorization from the client device at step 110. The customer account may be determined from the indication of the payment instrument received in the payment authorization received in step 110 and debited to ensure sufficient funds are available for the transaction before the payment authorization response is generated in step 120. Then, once the payment request has been received from the merchant device at step 140, the payment transaction can be completed by determining the merchant account based on the payment request and causing the merchant account to be credited in accordance with the payment authorization and the payment request.

In any event, it will be appreciated that the above method can allow a mobile payment from the customer to the merchant to be facilitated without requiring the client device and the merchant device to have dedicated mobile payment capabilities as traditionally required for mobile payments. Whilst most conventional mobile payment techniques require that the customer uses a mobile device having Near Field Communication (NFC) capabilities to make a mobile payment, in contrast the above method can be performed using any client device having a display with suitable resolution for displaying a barcode, suitable communications network connectivity, and a suitable user interface for allowing the payment amount and any required authentication information to be input. Similarly, whilst most conventional mobile payment techniques require that the merchant has dedicated mobile payment infrastructure, also having Near Field Communication (NFC) capabilities, in order to accept a mobile payment, in contrast the above method can be performed using any merchant device having a camera or other suitable barcode code scanning device, suitable communications network connectivity and a suitable user interface.

It will be understood that these device requirements may be readily satisfied by a wide range of electronic processing devices, including low cost entry level smart phones that may not be compatible with conventional mobile payment techniques. Accordingly, this method may help to remove some of the technological barriers that have impeded the adoption of conventional mobile payment techniques. In addition, by removing the need for the merchant to have dedicated mobile payment infrastructure, and allowing this to be replaced by a smart phone or similar mobile device, this can allow merchants to accept mobile payments more portably, such as in market stalls or mobile businesses.

It will be appreciated that the method may be beneficially applied to payments in a range of different scenarios. The method may be used to allow customers to purchase goods or services from merchants operating supermarkets, stores, shop fronts, market stalls, home businesses or mobile businesses, for example. Other applications may include facilitating customer payments for taxi or ride sharing services, or the purchase of tickets for sporting events, cultural events, or any other large population ticketed/payment events.

Further implementation features of the method will now be described.

In some examples, the method may include the payment authorization being generated by the client device in response to manual input by the customer using the client device. Typically this will involve the customer interacting with a graphical user interface presented on a display by the application software, such as by using a touch screen. The customer may be presented with options for selection or prompted to input data as required to allow the payment authorization to be generated. For instance, the customer may be required to manually input a selection of the payment instrument of the customer from a plurality of available payment instruments or to manually input the payment amount using the client device.

In some implementations, the method may include the customer manually inputting the payment amount in response to the merchant notifying the customer of a required payment amount for a customer purchase. It will be appreciated that this may involve the merchant may using a point of sale terminal to calculate a total payment amount for any goods or services to be purchased, and this payment amount may be confirmed to the customer verbally or presented on a display of the point of sale terminal, for example. The point of sale terminal used in this example may not necessarily be the same as the merchant device.

In some cases, the method may further include the merchant verifying the payment amount input by the customer prior to the payment authorization being generated. For instance, the customer may show the merchant the payment amount after it has been manually input using the client device, to allow the merchant to check the accuracy of the amount before the customer provides confirmation to proceed with the generation of the payment authorization.

In some examples, the method may include, upon receipt of the payment authorization, generating the barcode in the application server, and subsequently providing the barcode to the client device in the payment authorization response. Accordingly, in these examples the client device merely has to receive the pre-generated barcode and present this on its display. This prevents the need for the client device to generate the barcode locally, but transferring a barcode image may require more data to be transferred from the application server to the client device compared to the situation in which the barcode is locally generated in the client device, which could be problematic in regions with limited communications network bandwidth.

In alternative examples, the method may include, upon receipt of the payment authorization, the application server causing the client device to generate the barcode in accordance with the payment authorization response. This may involve having the application server provide the client device with payment information to be encoded in the barcode, and having the application software executed on the client device generate the barcode by encoding the payment information in the barcode. This may require less communications network bandwidth utilization in exchange for requiring the client device to perform a more computationally expensive barcode encoding operation.

As mentioned above, the barcode may a one-dimensional barcode, a two-dimensional barcode, a matrix barcode, a QR code, or any other suitable type of optical, machine-readable representation of encoded data.

In some implementations, the barcode may be generated so that a unique identifier associated with the payment is encoded in the barcode, as discussed above. The unique identifier may be associated with payment information for the payment, which may be stored in a database of the application server. Accordingly, the method may include having, upon receipt of the payment authorization, having the application server generate the unique identifier and provide the unique identifier to the client device in the payment authorization response. It should be appreciated that the unique identifier may be provided in an encoded form in a barcode that is provided as part of the payment authorization response, or the unique identifier may be provided in the payment authorization response without any encoding, to allow the barcode encoding the unique identifier to be generated by the client device.

In any event, the method may subsequently involve the merchant device, upon scanning the barcode, decoding the barcode to obtain the unique identifier and generating the payment request including the unique identifier and a merchant identifier. The merchant identifier may be associated with a merchant account or other merchant information stored in a database of the application server. The merchant identifier will typically be unique to the merchant and will allow the application server to determine the identity and preferred account of the merchant to thereby enable the payment to be performed in favour of the merchant.

Accordingly, in some implementations, the method may include the application server, upon receipt of the payment request, determining the unique identifier and the merchant identifier from the payment request, and causing the payment to be performed based on the unique identifier and the merchant identifier. Some examples of the method may involve the application server determining the payment amount based on the unique identifier and providing the payment amount to the merchant device. Alternative examples of the method may involve the barcode being generated so that the payment amount is also encoded in the barcode and the merchant device decoding the barcode to obtain the payment amount.

In either case, the merchant device may obtain the payment amount, which can be used to allow the merchant to verify the payment by confirming that the payment amount is correct before allowing the payment to proceed. Accordingly, in some examples the method may include presenting the payment amount on a display of the merchant device, and the merchant device generating the payment request in response to the merchant confirming the payment amount using the merchant device.

As mentioned above, in some implementations the method may involve having the payment instrument of the customer debited by the payment amount upon receipt of the payment authorization. This may involve the application server, upon receipt of the payment authorization from the client device, determining a customer account based on the indication of the payment instrument included in the payment authorization and subsequently causing the customer account to be debited by the payment amount in accordance with the payment authorization. At a later stage in the method, upon receipt of the payment request, the application server can cause the payment to be completed by determining a merchant account based on a merchant identifier included in the payment request and causing the merchant account to be credited in accordance with the payment request. In the event that the payment request is not received from the merchant within a predetermined time period after receipt of the payment authorization, the method may include reversing the debited payment amount on the customer account. This may occur, for instance, if the merchant does not scan the barcode from the client device or decides not to proceed with the payment if the payment amount is incorrect.

In alternative implementations, the payment may proceed in a more conventional process, by having the application server cause the payment to be performed by determining a customer account based on the indication of the payment instrument included in the payment authorization, determining a merchant account based on a merchant identifier included in the payment request and causing the customer account to be debited and the merchant account to be credited in accordance with the payment authorization and the payment request.

In any event, the method may include the application server causing the payment to be performed by generating a payment request message and providing the payment request message to a payment server. The method may also include providing a successful payment notification to the merchant device and/or the client device in response to a successful payment. Accordingly, the merchant can be assured that the payment has been received before providing goods or services to the customer and completing the transaction, and the client can receive a record of the payment, which may remove the need for a receipt in some cases.

In view of the above, it will be appreciated that a suitable system for facilitating a payment from a customer to a merchant will include one or more electronic processing devices. These will be configured to receive, from a client device of the customer, a payment authorization including an indication of a payment instrument of the customer for the payment and a payment amount for the payment. The one or more electronic processing devices will be configured to provide, to the client device, a payment authorization response, the payment authorization response causing the client device to present a barcode associated with the payment on a display of the client device, the barcode being scanned by a merchant device of the merchant. The one or more electronic processing devices will also be configured to receive, from the merchant device, a payment request generated in response to the merchant device scanning the barcode. Finally, the one or more electronic processing devices will also be configured to cause the payment from the payment instrument of the customer to the merchant to be performed in accordance with the payment authorization and the payment request.

From the perspective of the client device of the customer, an example implementation of the method may involve the following steps. The client device will first generate a payment authorization including an indication of a payment instrument of the customer for the payment and a payment amount for the payment. Then, the client device will provide, to an application server, the payment authorization. The client device will subsequently receive, from the application server, a payment authorization response. Finally, the client device will present a barcode associated with the payment on a display of the client device in accordance with the payment authorization response. This will allow a merchant device of the merchant to scan the barcode and provide, to the application server, a payment request generated in response to the merchant device scanning the barcode, to thereby allow the application server to cause the payment from the payment instrument of the customer to the merchant to be performed in accordance with the payment authorization and the payment request.

On the other hand, from the perspective of the merchant device of the merchant, an example implementation of the method may involve the following steps. First, the merchant device will scan, from a display of a client device of the customer, a barcode associated with the payment. The barcode may encode a unique identifier associated with the payment and is presented on the display in accordance with a payment authorization response generated by an application server in response to the client device generating payment authorization including: an indication of a payment instrument of the customer for the payment and a payment amount for the payment. The merchant device will then decode the barcode to obtain the unique identifier, and then generate a payment request in response to the merchant device scanning the barcode. The payment request may include the unique identifier and a merchant identifier. Finally, the merchant device will provide, to an application server, the payment request. This will allow the application server to cause the payment from the payment instrument of the customer to the merchant to be performed in accordance with the payment authorization and the payment request.

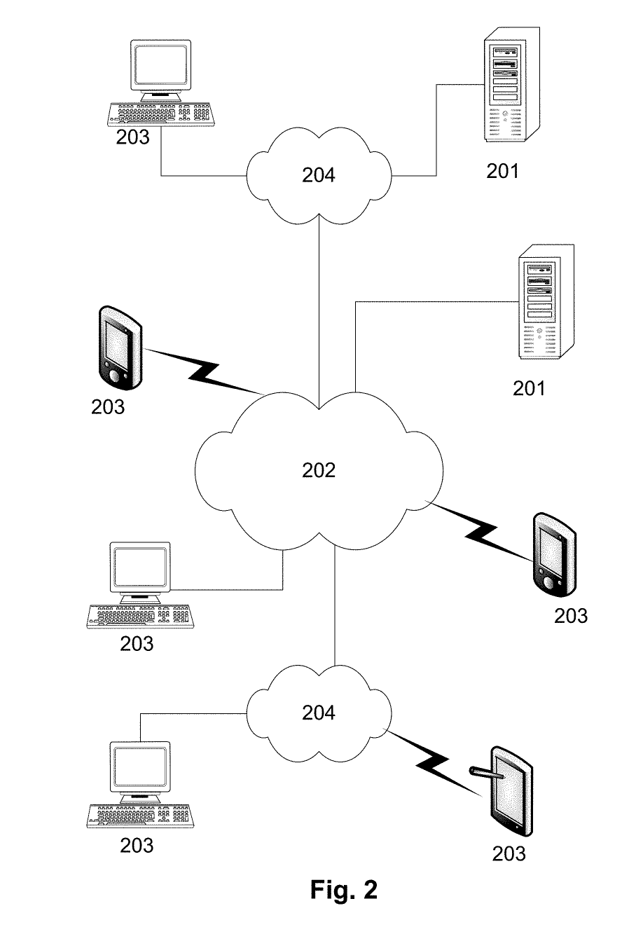

In one example, the process is performed by one or more processing systems operating as part of a distributed architecture, an example of which will now be described with reference to FIG. 2.

In this example, the arrangement includes a number of processing systems 201, 203 interconnected via one or more communications networks, such as the Internet 202, and/or a number of local area networks (LANs) 204. It will be appreciated that the configuration of the networks 202, 204 are for the purpose of example only, and in practice the processing systems 201, 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The nature of the processing systems 201, 203 and their functionality will vary depending on their particular requirements. In one particular example, the processing systems 201, 203 represent servers and clients, although this is not essential and is used primarily for the purpose of illustration.

An example of a suitable processing system 201 is shown in FIG. 3. In this example, the processing system 201 includes an electronic processing device, such as at least one microprocessor 300, a memory 301, an optional input/output device 302, such as a keyboard and/or display, and an external interface 303, interconnected via a bus 304 as shown. In this example the external interface 303 can be utilised for connecting the processing system 201 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing systems 201, 203. Thus, actions performed by a processing system 201 are performed by the processor 300 in accordance with instructions stored as applications software in the memory 301 and/or input commands received via the I/O device 302, or commands received from other processing systems 201, 203. The applications software may include one or more software modules, and may be executed in a suitable execution environment, such as an operating system environment, or the like.

Accordingly, it will be appreciated that the processing systems 201 may be formed from any suitable processing system, such as a suitably programmed computer system, PC, web server, network server, or the like. In one particular example, the processing system 201 is a standard processing system such as a 32-bit or 64-bit Intel Architecture based processing system, which executes software applications stored on non-volatile (e.g., hard disk) storage, although this is not essential. However, it will also be understood that the processing systems 201 could be or could include any electronic processing device such as a microprocessor, microchip processor, logic gate configuration, firmware optionally associated with implementing logic such as an FPGA (Field Programmable Gate Array), or any other electronic device, system or arrangement.

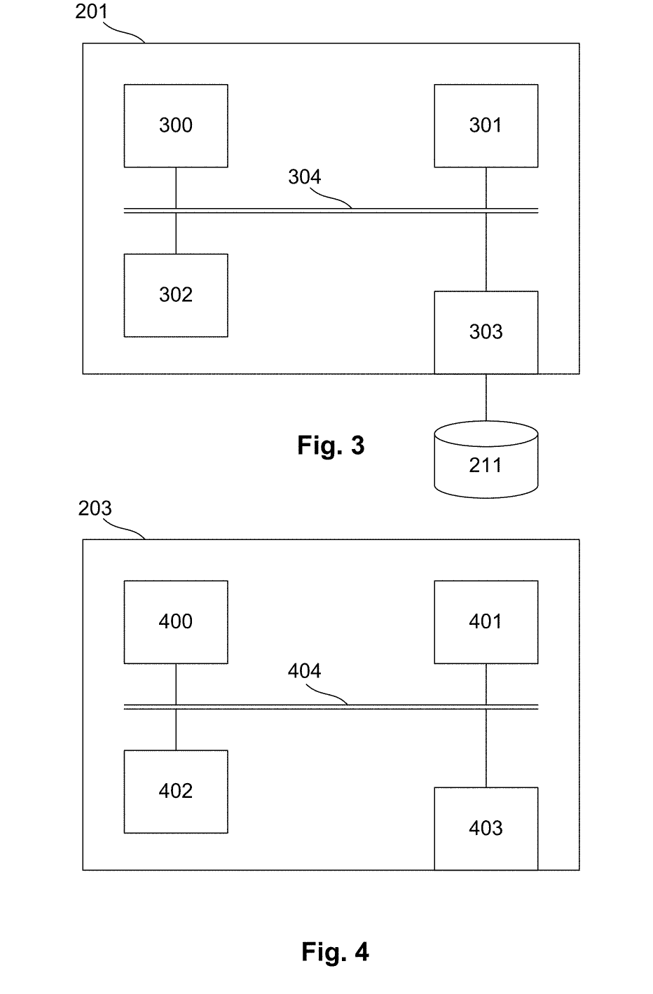

As shown in FIG. 4, in one example, the processing systems 203 include an electronic processing device, such as at least one microprocessor 400, a memory 401, an input/output device 402, such as a keyboard and/or display, and an external interface 403, interconnected via a bus 404 as shown. In this example the external interface 403 can be utilised for connecting the processing system 203 to peripheral devices, such as the communications networks 202, 204, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to perform required processes, for example to allow communication with other processing systems 201, 203. Thus, actions performed by a processing system 203 are performed by the processor 401 in accordance with instructions stored as applications software in the memory 402 and/or input commands received from a user via the I/O device 403. The applications software may include one or more software modules, and may be executed in a suitable execution environment, such as an operating system environment, or the like.

Accordingly, it will be appreciated that the processing systems 203 may be formed from any suitable processing system, such as a suitably programmed PC, Internet terminal, lap-top, hand-held PC, smart phone, PDA, tablet, or the like. Thus, in one example, the processing system 203 is a standard processing system such as a 32-bit or 64-bit Intel Architecture based processing system, which executes software applications stored on non-volatile (e.g., hard disk) storage, although this is not essential. However, it will also be understood that the processing systems 203 can be any electronic processing device such as a microprocessor, microchip processor, logic gate configuration, firmware optionally associated with implementing logic such as an FPGA (Field Programmable Gate Array), or any other electronic device, system or arrangement.

It will also be noted that whilst the processing systems 201, 203 are shown as single entities, it will be appreciated that this is not essential, and instead one or more of the processing systems 201, 203 can be distributed over geographically separate locations, for example by using processing systems provided as part of a cloud based environment.

For the purpose of the following detailed examples, it is assumed that the client devices used by the customers and the merchants will each be provided by processing systems 203 executing suitable application software. Furthermore, it is assumed that the client devices of the customers include a display capable of presenting barcodes at a suitable resolution for optical scanning, whilst the merchant devices are capable of scanning barcodes, such as by using an in-built camera or other suitable scanning device.

The process may be facilitated by one or more of the processing systems 201, acting as application servers. Other processing systems 201 may act as payment servers operated by payment service providers, financial institutions or the like. The payment servers will be responsible for actually performing the payments in a conventional manner, once the payments have been facilitated by the application servers in accordance with the method.

As depicted in FIG. 2, the processing systems 201 acting as application servers and/or payment servers and processing systems 203 acting as client devices and merchant devices may be connected to communications networks 202, 204 in different configurations, to allow communication between the different processing systems 201, 203 via the Internet 202.

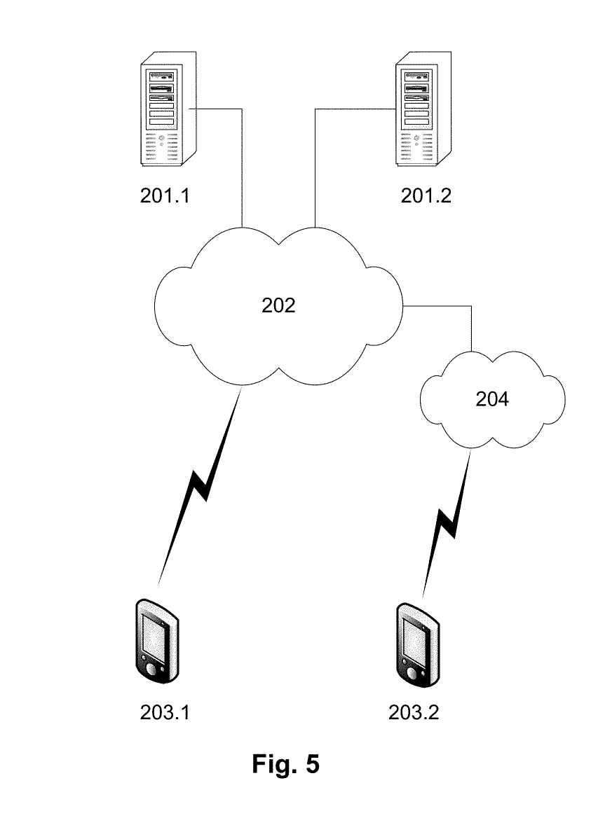

A particular example of a system configuration for facilitating a payment from the customer to the merchant, which is assumed to be used in the following detailed example, will now be described with regard to FIG. 5.

In this example, the customer uses a client device 203.1 in the form of a smart phone having a display capable of presenting barcodes at a suitable resolution as mentioned above. Typically the client device 203.1 will be configured to connect to the Internet 202. In this case the client device 203.1 of the customer wirelessly connects to the Internet 202 and has a data plan on a mobile network for allowing the consumption of mobile data via the Internet 202. The client device 203.1 will typically execute application software for enabling the functionalities required to perform the method. The customer will interact with their client device 203.1 to open the application software for initiating a payment and to authorise the payment by selecting a payment instrument and inputting a payment amount.

In this example, the merchant uses a client device 203.2 that is capable of scanning the barcode presented on the display of the client device 203.1. The merchant's client device 203.2 will be referred to as a merchant device 203.2 to distinguish this from the customer's client device 203.1. It should be appreciated that the merchant does not require a POS terminal or any supporting infrastructure for accepting card or mobile payments. The merchant device 203.2 may be a mobile device such as a smart phone similar to that described above for the client device 203.1, a tablet, or any other suitable computing device. Alternatively, the merchant device 203.2 may be in the form of a stationary computing device such as a suitably programmed PC. In this example, the merchant device 203.2 is a smart phone of the merchant.

For the purpose of this example, it will be assumed that the merchant device 203.2 is located in a place of business of the merchant, although this is not essential and the method may be implemented to allow portable payments in any location with suitable communications network connectivity. The merchant device 203.2 may be connected wirelessly to the Internet 202 as per the client device 203.1, although in this example, it is assumed that the merchant device 203.2 is connected to a wireless local area network 204 in the place of business of the merchant which is in turn connected to the Internet 202 via a wired connection, as shown in FIG. 5.

In this example, the system includes an application server 201.1 which may be configured to send and receive information to and from client devices 203.1, 203.2 to facilitate the payment process. The client devices 203.1, 203.2 will usually be connected to the application server 201.1 via the Internet 202. The application server 201.1 may include a database 211 for storing payment information for each payment along with registered user details such as details of customer accounts and merchant accounts.

The application server 201.1 will be configured to receive the payment authorization from the client device 203.1, provide a payment authorization response which may include a barcode or payment information to be encoded into a barcode by the client device 203.1, receive a payment request from the merchant device 203.2 in response to the barcode being scanned, and cause the payment to be performed, such as by communicating with a payment server 201.2. In addition, the application server 201.1 may be configured to provide payment notifications to client devices 203.1 and merchant devices 203.2 depending on the success or failure of payments. The application server 201.1 may also be configured to send/receive other information to/from the client devices 203.1 or merchant devices, such as for the registration of new customers or merchants or to enable ongoing configuration changes by the customers or merchants.

The application software executed by each client device 203.1, 203.2 will typically be configured to facilitate these and other information transfers. The customer or merchant may interact with the application server via a GUI (Graphical User Interface), or the like, presented on their respective processing systems 203.1, 203.2, such as via the application software or optionally via a browser application that displays webpages hosted by the application server 201.1.

Depending on the payment instrument being used, the application server 201.1 may communicate with a separate payment server 201.2 operated by a payment service provider or the like to actually cause the payment to be performed. This communication will typically also be achieved via the Internet 202. The payment server may in turn communicate with a payment network to perform the payment, in a generally conventional manner.

However, it will be appreciated that the above described configuration assumed for the purpose of the following examples is not essential, and numerous other configurations may be used. It will also be appreciated that the partitioning of functionality between the processing systems 201, 203 may vary, depending on the particular implementation.

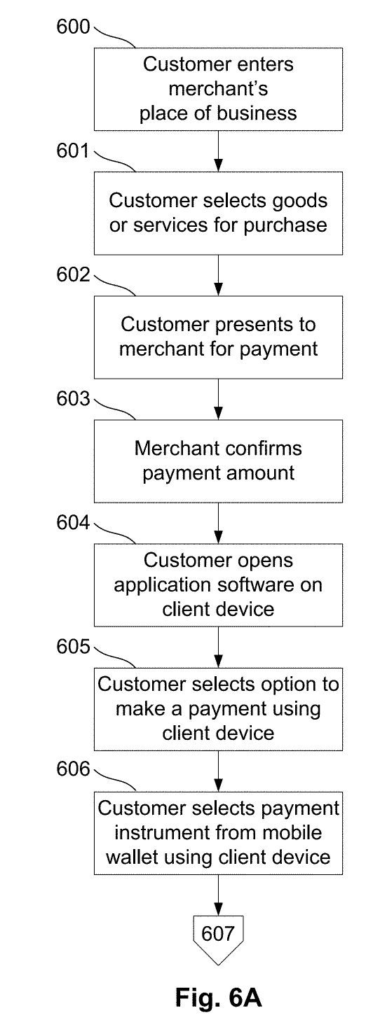

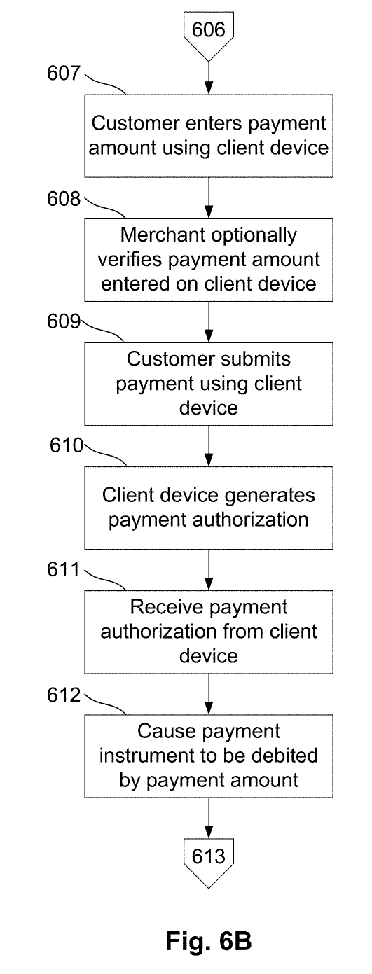

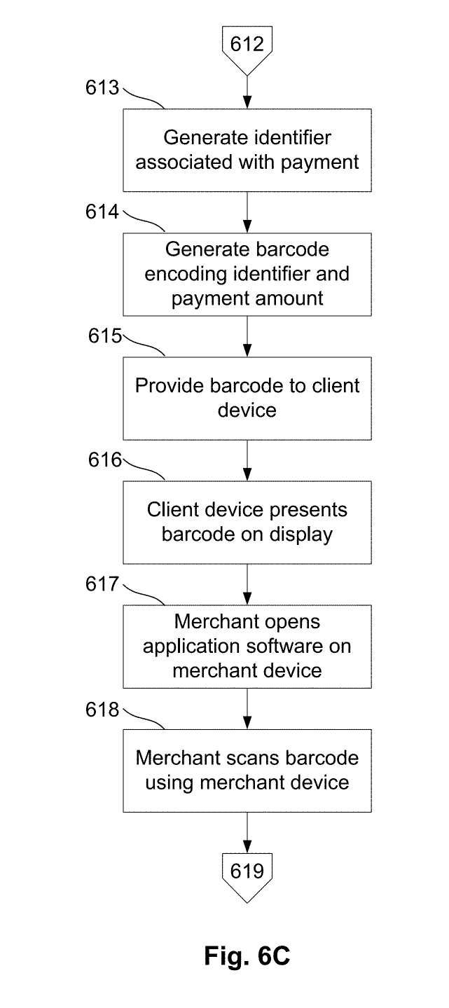

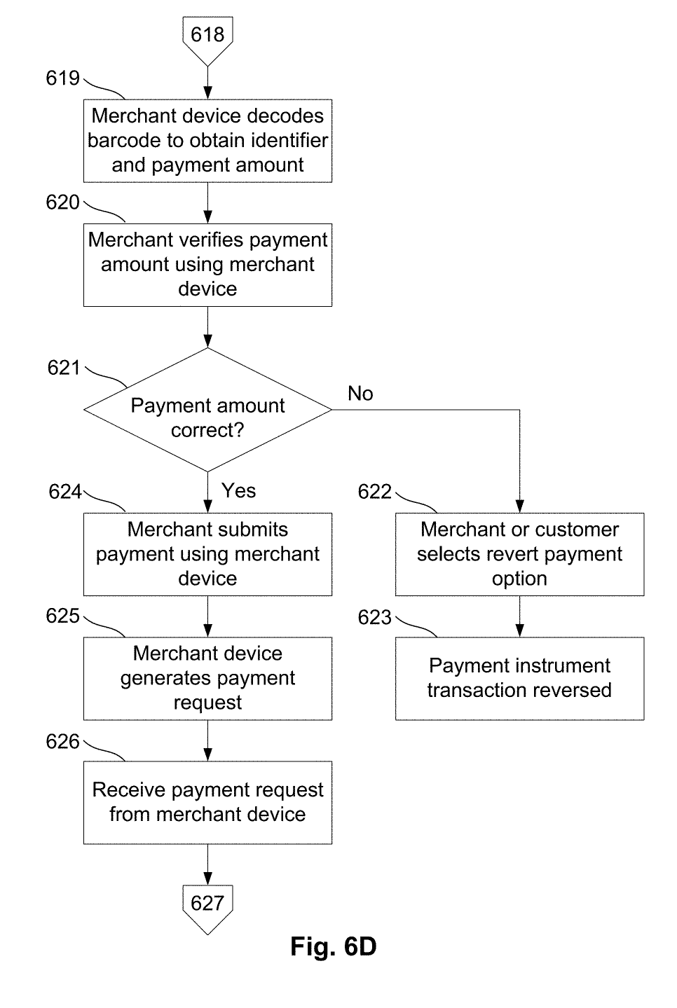

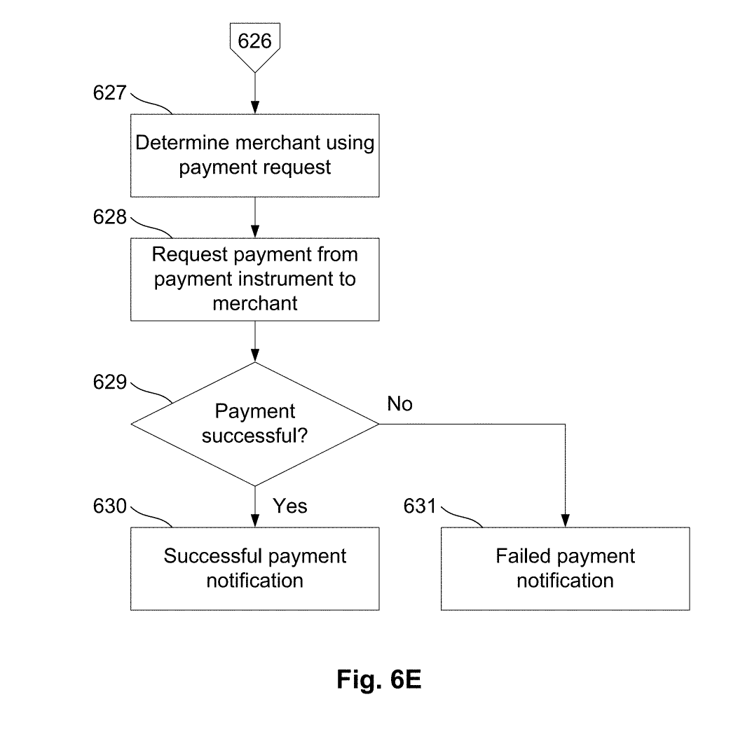

A detailed example of a method of a customer making a payment to a merchant using the above discussed techniques will now be described with regard to the flow chart of FIGS. 6A to 6E.

This example assumes that the customer's client device 203.1 is a smartphone having a suitable display for barcode presentation and a data plan for consumption of mobile data and having a suitable version of the application software for facilitating the process installed, as discussed above. The customer is assumed to be already registered as a user of the application software, and is also assumed to have a mobile wallet containing one or more tokenized payment instruments (credit cards, debit cards, prepaid cards, and/or gift cards for example) as mentioned earlier. Typically, when the customer initially registers as a user, the customer will set up the application software by connecting their tokenized mobile wallet to the application software in preparation for future payments.

This example also assumes that the merchant has already been registered with an acquiring bank to accept payments. As part of the registration process, merchant information such as details of the merchant account will typically be provided to the application server 201.1 and stored in its database 211. The registration process may take place by having the merchant interact with a merchant device 203.2 to input required merchant information. A merchant identifier may be associated with the merchant information to allow the application server 201.1 to identify the merchant in payment requests generated by the merchant device 203.2.

In step 600, the customer enters the merchant's place of business, and selects goods or services for purchase in step 601. The customer presents to the merchant for payment in step 602. The merchant may process the customer's order of goods or services in a generally conventional manner, depending on the nature of the merchant's business. For instance, the merchant may process the customer's order using a suitably configured register if available, or may simply calculate a total payment amount for the order using a calculator or by manual calculations.

In any event, the merchant will confirm a payment amount required from the customer at step 603. The payment amount may be confirmed to the customer verbally or displayed on a register or the like. Upon confirmation of the payment amount, the customer will open the application software on their client device 203.1 to initiate the payment process at step 604.

Typically, when the application software is opened on the client device 203.1, the customer will be presented with different options depending on the functionalities of the application software. In this case, at step 605 the customer selection an option to make a payment using the client device. The customer may then commence authorization of the payment.

In step 606, the customer may select a payment instrument, such as a credit/debit card, bank account, gift card or the like, from the mobile wallet on the client device 203.1. In the event that the customer has multiple payment instruments in their mobile wallet, this may involve the client device 203.1 displaying indications of each available payment instrument and having the customer manually select one of these using the client device 203.1. Alternatively, if only one payment instrument is available, the customer may simply input their confirmation to proceed with a payment based on that payment instrument.

Next, in step 607, the customer will input the payment amount (previously confirmed by the merchant in step 603) using the client device. This may simply involve the customer entering the payment amount using a numerical keypad interface of the client device 203.1, which may be presented on a touch screen display of the client device 203.1, for example.

At step 608, the merchant may optionally be given an opportunity to verify the payment amount the customer has entered on the client device 203.1. This may simply involve the customer showing the merchant the payment amount on the display of the client device 203.1 before moving on from the payment amount input interface.

When the customer has selected a desired payment instrument for the payment, and has input the payment amount, the payment may be authorized. This may require the customer to participate in a further authentication step such as entering a password or personal identification number, or using biometric authentication such as by scanning the customer's fingerprint. In some implementations, two-factor authentication techniques may be used.

When the customer is ready to proceed with the payment, the customer may use the client device to submit the payment at step 609. Once the payment has been authorized by the customer, the client device 203.1 will generate a payment authorization at step 610 and provide this to the application server 201.1. As mentioned above, the payment authorization will include the indication of the payment instrument and the payment amount.

At step 611, the application server 201.1 receives the payment authorization from the client device 203.1. The application server 201.1 will then determine the payment instrument and the payment amount from the payment authorization for use in performing the payment.

In this example, the application server 201.1 causes payment instrument selected by the customer and indicated in the payment authorization to be debited by the payment amount at step 612. For example, when the payment instrument is a credit card, the application server 201.1 may communicate with a payment server 201.2 operated by a payment service provider, to cause a transaction to be send to an issuer switch for the customer's credit card. As discussed above, this can ensure that adequate funds are available before proceeding with the subsequent steps of the payment transaction, but this step is not essential.

The application server 201.1 will also generate a unique identifier associated with the payment as per step 613. In this example, the application server 201.1 is configured to generate the barcode encoding the unique identifier and the payment amount at step 614 and subsequently provide the barcode to the client device 203.1 at step 615, as part of the payment authorisation response that is provided to the client device 203.1. However, as mentioned above, alternative implementations may involve providing the unique identifier and other optional payment information to the client device 203.1 in the payment authorization response to allow the barcode to be generated locally on the client device 203.1.

In any event, the client device 203.1 will present the barcode on its display at step 616 to enable this to be scanned by the merchant. At step 617, the merchant opens the application software on the merchant device, and may select an option to scan a barcode for a payment. At step 618, the merchant uses the merchant device 203.2 to scan the barcode, typically using an in-built camera of the merchant device or a scanning device coupled to the merchant device 203.2.

At step 617, the merchant device 203.2 decodes the barcode to obtain the unique identifier and the payment amount that were embedded in the barcode. Typically the application software executed by the merchant device 203.2 will include a capability for scanning and decoding the type of barcode to be presented by the application software executed by the client device 203.1.

The merchant will be given an opportunity to verify the payment amount using the merchant device 203.2 at step 620. This may involve presenting the payment amount on a display of the merchant device 203.2 to allow the merchant to review the payment amount and confirm whether this is correct compared to the total payment amount that was previously calculated and confirmed to the customer prior to entry in the client device 203.1.

If the payment amount is found to be incorrect at step 621, then the merchant or the customer can select a revert payment option on their respective device at step 622, which in turn will cause the payment instrument transaction performed at step 612 to be reversed. In some examples, only the customer may have the option to revert the payment, in which case the merchant may suggest to the customer to revert the payment. The revert option may be provided in a similar manner to the VOID option in conventional POS transactions, such that the transaction may be reversed instantaneously.

On the other hand, if the payment amount is found to be correct at step 621, then the merchant will submit the payment using the merchant device 203.2 at step 624. This may involve the merchant selecting a confirmation button presented on the merchant device 203.2 along with the payment amount for verification. Following this, the merchant device 203.2 will generate a payment request at step 625. The payment request will typically include at least the unique identifier associated with the payment and the merchant identifier.

The payment request is then transferred from the merchant device 203.1 to the application server 201.1 at step 626. Upon receipt of the payment request, at step 627 the application server 201.1 may determine the merchant using the merchant identifier provided in the payment request. This also allows the application server 201.1 to confirm the merchant account for receiving the payment. Then, the application server 201.1 may then proceed to cause the payment to be completed.

In this example, at step 628 the application server 201.1 communicates with a payment server 201.2 to request payment from the customer's selected payment instrument to the selected merchant's account with their acquiring bank. This may involve the application server 201.1 generating a suitable payment request message in a suitable format for providing to the payment server 201.2, to allow the payment server to perform the payment on a conventional payment network.

In step 629, the application server 201.1 will determine whether the payment has been successfully performed, typically based on a message returned from the payment server 201.2. In the event of a successful payment, a successful payment notification may be generated at step 630. This successful payment notification may be provided to the client device 203.1 and/or the merchant device 203.2 depending on the implementation. In the case of the client device 203.1, the successful payment notification may be provided via the application software to provide a seamless confirmation that the customer's payment to the merchant has been processed to completion. In some implementations, the merchant may request to view the successful payment notification on the customer's client device 203.1, and this may be adequate confirmation of the payment for the merchant to release the goods and services to the customer.

However, more typically the merchant will wish to receive their own verification of the payment, and therefore a successful payment notification may also be provided to the merchant via the merchant device 203.2. The nature of the successful payment notification provided to the merchant device 203.2 can vary depending on requirements. In some cases, the merchant device 203.2 may also execute application software for communication with the application server 201.1, and the successful payment notification may take the form of a push notification provided by the application software. In other examples, the merchant device 203.2 may receive the successful payment notification via any suitable messaging service, such as short message service (SMS) or email.

If the payment is unsuccessful, the application server 201.1 would instead provide a failed payment notification to the client device 203.1 and/or the merchant device 203.2 in a similar manner as discussed for the successful payment notification. In this case, the customer and the merchant may agree to cancel the transaction or the customer may make another payment attempt, such as by using an alternative payment instrument. The failed payment notification may include an indication of why the payment was unsuccessful, to allow the customer to modify their next payment attempt accordingly.

As discussed above, this example involves debiting the customer account once the application server 201.10 receives the payment authorization from the client device 203.1. However, in this example, this debit process will only be valid for a predetermined time period. For instance, if the merchant does not submit the payment and cause a payment request to be received by the application server 201.1 within 5 minutes of the payment authorization, a reversal of the payment may be generated.

In this example, the payment transaction may be treated as a dual message transaction, where auto settlement may occur in the acquirer switch automatically at end of day. All other processes of transaction/settlement and chargeback shall remain the same as conventional transaction processes. The merchant shall not be expected to settle his batch at end of day.

In any event, in view of the above examples, it will be appreciated that the methods and systems described above facilitate mobile payments from customers to merchants that do not have mobile payment infrastructure. This provides a means for merchant's to accept cashless payments even if they cannot afford supporting infrastructure. Furthermore, the methods and systems described above allow mobile payments using client devices that do not necessarily include enabling technologies such as NFC that are typically needed for conventional mobile payments. This helps to substantially reduce the technological and cost barriers impeding widespread adoption of mobile payments.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A system for facilitating a payment from a customer to a merchant, the system including one or more electronic processing devices configured to:
a) receive, from a client device of the customer, a payment authorization including:
i) an indication of a payment instrument of the customer for the payment; and,
ii) a payment amount for the payment;
b) provide, to the client device, a payment authorization response, the payment authorization response causing the client device to present a barcode associated with the payment on a display of the client device for scanning by a merchant device of the merchant;
c) receive, from the merchant device, a payment request generated in response to the merchant device scanning the barcode; and,
d) cause the payment from the payment instrument of the customer to the merchant to be performed in accordance with the payment authorization and the payment request.

2) A system according to claim 1, wherein the payment authorization being generated by the client device in response to manual input by the customer using the client device.

3) A system according to claim 2, wherein the customer manually inputs a selection of the payment instrument of the customer from a plurality of available payment instruments, and manually inputs the payment amount using the client device, the customer manually inputting the payment amount in response to the merchant device notifying the client device of a required payment amount for a customer purchase, and the merchant device verifying the payment amount input by the customer prior to the payment authorization being generated.

4) A system according to claim 1, the one or more electronic processing devices being further configured to, upon receipt of the payment authorization:
a) generate the barcode; and,
b) provide the barcode to the client device in the payment authorization response.

5) A system according to claim 1, the one or more electronic processing devices being further configured to, upon receipt of the payment authorization, cause the client device to generate the barcode in accordance with the payment authorization response, the barcode being generated so that a unique identifier associated with the payment is encoded in the barcode.

6) A system according to claim 5, the one or more electronic processing devices being further configured to, upon receipt of the payment authorization:
a) generate the unique identifier; and,
b) provide the unique identifier to the client device in the payment authorization response.

7) A system according to claim 5, wherein the merchant device, upon scanning the barcode,
a) decodes the barcode to obtain the unique identifier; and,
b) generates the payment request including the unique identifier and a merchant identifier.

8) A system according to claim 7, the one or more electronic processing devices being further configured to, upon receipt of the payment request:
a) determine the unique identifier and the merchant identifier from the payment request; and,
b) cause the payment to be performed based on the unique identifier and the merchant identifier.

9) A system according to claim 8, the one or more electronic processing devices being further configured to, upon receipt of the payment request:
a) determine the payment amount based on the unique identifier; and,
b) provide the payment amount to the merchant device.

10) A system according to claim 7, the one or more electronic processing devices being further configured to:
a) generate the barcode so that the payment amount is also encoded in the barcode; and,
b) decode, at the merchant device, the barcode to obtain the payment amount.

11) A system according to claim 9, the one or more electronic processing devices being further configured to
present the payment amount on a display of the merchant device,
wherein the merchant device generates the payment request in response to the merchant device confirming the payment amount.

12) A system according to claim 1, wherein the barcode is at least one of:
a) a one-dimensional barcode;
b) a two-dimensional barcode;
c) a matrix barcode; and,
d) a QR code.

13) A system according to claim 1, the one or more electronic processing devices being further configured to, upon receipt of the payment authorization from the client device:
a) determining a customer account based on the indication of the payment instrument included in the payment authorization; and,
b) causing the customer account to be debited by the payment amount in accordance with the payment authorization.

14) A system according to claim 13, the one or more electronic processing devices being further configured to, upon receipt of the payment request:
a) determine a merchant account based on a merchant identifier included in the payment request; and
b) cause the merchant account to be credited in accordance with the payment request.

15) A system according to claim 13, the one or more electronic processing devices being further configured to, in the event that the payment request is not received from the merchant within a predetermined time period after receipt of the payment authorization, reverse the debited payment amount on the customer account.

16) A system according to claim 1, the one or more electronic processing devices being further configured to cause the payment to be performed by:
a) determining a customer account based on the indication of the payment instrument included in the payment authorization;
b) determining a merchant account based on a merchant identifier included in the payment request; and
c) causing the customer account to be debited and the merchant account to be credited in accordance with the payment authorization and the payment request.

17) A system according to claim 1, the one or more electronic processing devices being further configured to cause the payment to be performed by generating a payment request message and providing the payment request message to a payment server.

18) A system according to claim 13, the one or more electronic processing devices being further configured to, in response to a successful payment, provide a successful payment notification to at least one of:
a) the client device; and,
b) the merchant device.

19) A method for facilitating a payment from a customer to a merchant, the method being performed using one or more electronic processing devices, the method including:
a) receiving, from a client device of the customer, a payment authorization including:
i) an indication of a payment instrument of the customer for the payment; and,
ii) a payment amount for the payment;
b) providing, to the client device, a payment authorization response, the payment authorization response causing the client device to present a barcode associated with the payment on a display of the client device for scanning by a merchant device of the merchant;
c) receiving, from the merchant device, a payment request generated in response to the merchant device scanning the barcode; and,
d) causing the payment from the payment instrument of the customer to the merchant to be performed in accordance with the payment authorization and the payment request.

20) A client device for facilitating a payment from a customer to a merchant, the client device being configured to:
a) generate a payment authorization including:
i) an indication of a payment instrument of the customer for the payment; and,
ii) a payment amount for the payment;
b) provide, to an application server, the payment authorization;
c) receive, from the application server, a payment authorization response;
d) present a barcode associated with the payment on a display of the client device in accordance with the payment authorization response, to allow a merchant device of the merchant to scan the barcode and provide, to the application server, a payment request generated in response to the merchant device scanning the barcode, to thereby allow the application server to cause the payment from the payment instrument of the customer to the merchant to be performed in accordance with the payment authorization and the payment request.

21) A merchant device for facilitating a payment from a customer to a merchant, the merchant device being configured to:
a) scan, from a display of a client device of the customer, a barcode associated with the payment, the barcode encoding a unique identifier associated with the payment and being presented on the display in accordance with a payment authorization response generated by an application server in response to the client device generating payment authorization including:
i) an indication of a payment instrument of the customer for the payment; and,
ii) a payment amount for the payment;
b) decode the barcode to obtain the unique identifier;
c) generate a payment request in response to the merchant device scanning the barcode, the payment request including the unique identifier and a merchant identifier; and,
d) provide, to an application server, the payment request to thereby allow the application server to cause the payment from the payment instrument of the customer to the merchant to be performed in accordance with the payment authorization and the payment request.
